(19) United States
(12) Patent Application Publication
(10) Pub. No.: US 2004/0021682 A1
(43) Pub. Date: Feb. 5, 2004

(54) Intelligent product selector

(76) Inventor: Jason A. Pryor, Rockford, IL (US)

Correspondence Address: TREXLER, BUSHNELL, GIANGIORGI,, BLACKSTONE & MARR, LTD., 105 WEST ADAMS STREET, SUITE 3600, CHICAGO, IL, 60603, US

(21) Appl. No.: 10/374,386

(22) Filed: Feb. 25, 2003

Related U.S. Application Data
(60) Provisional application No. 60/399,897, filed on Jul. 31, 2002.

(51) Int. Cl. G09G 5/00

(52) U.S. Cl. 345/709; 345/854

(57) ABSTRACT

An embodiment of the present invention provides a novel web site architecture and a method of using same, where the web site is configured to guide users through the process of selecting the best tool or product for a specific job. The web site architecture is preferably a three-tiered design which has a presentation layer hosted on a first server, an application layer which is hosted on a second server, and a database layer which is hosted on the second server. The web site architecture is preferably based on the CMV (Control, Model and View) style. The application layer includes Java Server Pages, Servlets and Java Beans. The Servlets are responsible for instantiating the appropriate Java Beans and then transferring the flow to the Java Server Pages. The web site architecture further preferably provides a basic searchable catalog and allows users to find products that meet specific functional requirements.

### CROSS-REFERENCE

This patent application claims the benefit of domestic priority of U.S. Provisional Application Serial No. 60/399,897, filed Jul. 31, 2002, and entitled “Intelligent Product Selector”.

### BACKGROUND OF THE INVENTION

The present invention generally relates to web site architectures and methods of using same, and more specifically relates to a web site architecture and a method of using same, wherein the web site is configured to guide users through the process of selecting the best tool or product for a specific job.

Since the inception of the Internet, many companies have set up web sites which provide information regarding all or most of its products.

In a typical scenario, an individual will have the need for a product, e.g., a tool, for performing a specific job, e.g., forming a hole through a workpiece. If the individual does not already have the tool to form the desired hole, the individual will typically seek out a place where he/she can buy such a tool. One route in which the individual may go to find such a tool is to search the Internet for a web site which sells an appropriate tool.

Generally, the individual will either know of companies that make or sell the general type of tool that the individual needs, or the individual will search the Internet through a search engine to find a company that makes or sells the general type of tool that the individual needs.

Once the individual has found an appropriate web site, the web site will generally be configured to have a link to illustrate its products, such as a “Product Info” link. Once the individual selects the “Product Info” link, the individual will be linked to a web page which generally lists the different types of products that the company either makes or sells, for instance, products relating to bending, products relating to holemaking, hand tools, products relating to storage boxes, etc.

If the individual knows that he/she is looking for a holemaking tool, the individual then selects the products relating to holemaking, which will link the individual to another web page listing the different types of holemaking products that the company either makes or sells. The individual can then select specific types of holemaking products where a picture of the product will generally be shown and the product will be discussed in more detail for its specific purpose, tolerances, etc.

A problem with such a system, though, is that many times the individual may not know exactly what type of tool is needed to perform a certain job and, thus, will waste time surfing through the web site in an attempt to find the right tool.

Web sites listing products for specific jobs also do not generally contain all of the business logic used to retrieve, manipulate and store the data for the products.

Further, web sites are generally limited in flexibility and provide security risks to both the users and to the administrators of the web sites.

Also, distributors typically use one program for inventory and pricing, or possibly a second program for pricing, and a product line book or the Internet (a web site of the type described hereinabove) to order the product. Thus, distributors have the same problem as individuals with regard to figuring out what tool will work for the job.

Thus, there is a need for a web site that has an architecture makeup whereby the individual will have an easier time navigating the web site to find the exact product that he/she needs for a specific job. There is also a need for a web site that has an architecture makeup whereby the individual can tell the web site about the job to be performed, and the web site suggests products which can do the job. Further, there is also a need for distributors to access a web site through an Extranet to handle pricing, inventory and tool selection.

### OBJECTS AND SUMMARY OF THE INVENTION

It is a primary object of an embodiment of the invention to provide a web site architecture which is configured to guide users through the process of selecting the best product for a specific job.

It is an object of an embodiment of the invention to provide a web site architecture which has a three-tiered design where each layer runs independently of the other layers and can be separated both logically and physically.

It is another object of an embodiment of the invention to provide a web site architecture which has a three-tiered design where one of the layers contains all of the,business logic used to retrieve, manipulate and store data.

Yet another object of an embodiment of the invention is to provide a web site architecture that has a basic searchable catalog which allows users to find products that meet specific functional requirements.

Still another object of an embodiment of the invention is to provide a web site architecture that has a search function allowing a user to enter product names, UPC numbers or catalog numbers to get a listing of products matching the search criterion.

Yet another object of an embodiment of the invention is to provide a web site architecture that will allow for multiple languages to be input.

Another object of an embodiment of the invention is to provide a web site architecture which can be run on both an Internet web site and on an Extranet web site.

Still another object of an embodiment of the invention is to provide a web site architecture which allows the configuration of an order by selecting product and quantities of same for the purpose of purchase or quote.

Yet another object of an embodiment of the invention is to provide a web site architecture that has a means to compare two or more similar products in a single view which lists each product's attributes.

Another object of an embodiment of the invention is to provide a web site architecture that has a means to reference alternative, additional/accessory, and competitive products related to a specific product within a catalog of products.

Another object of an embodiment of the invention is to provide a web site architecture that has a means to link subordinate products to a specific product within a catalog of products.

Briefly, and in accordance with at least one of the foregoing objects, an embodiment of the present invention provides a novel web site architecture and a method of using same, where the web site is configured to guide users through the process of selecting the best tool or product for a specific job. The web site architecture is preferably a three-tiered design which has a presentation layer hosted on a first server, an application layer which is hosted on a second server, and a database layer which is hosted on the second server. The web site architecture is preferably based on the CMV (Control, Model and View) style. The application layer includes Java Server Pages, Servlets and Java Beans. The Servlets are responsible for instantiating the appropriate Java Beans and then transferring the flow to the Java Server Pages. The web site architecture further preferably provides a basic searchable catalog and allows users to find products that meet specific functional requirements.

### BRIEF DESCRIPTION OF THE DRAWINGS

The features of the present invention which are believed to be novel are described in detail hereinbelow. The organization and manner of the structure and operation of the invention, together with further objects and advantages thereof, may best be understood by reference to the following description taken in connection with the accompanying drawing wherein like reference numerals identify like elements in which:

FIG. 1 is a block diagram of a web site architecture which is in accordance with an embodiment of the present invention, wherein the architecture includes three layers: a presentation layer, an application layer, and a database layer;

FIG. 2 is a block diagram of a presentation layer of the web site architecture of an embodiment of the present invention, wherein the presentation layer includes HTML files;

FIG. 3 is a block diagram of an application layer of the web site architecture of an embodiment of the present invention, wherein the application layer includes JSPS, Servlets and Java Beans;

FIG. 4 is a block diagram illustrating the JSPs included in the application layer of the web site architecture of an embodiment of the present invention;

FIG. 5 is a block diagram illustrating the Servlets included in the application layer of the web site architecture of an embodiment of the present invention;

FIG. 6 is a block diagram illustrating the Java Beans included in the application layer of the web site architecture of an embodiment of the present invention;

FIGS. 7a-7e are block diagrams illustrating the Servlets responsible for instantiating the appropriate Java Beans and then transferring the flow to the appropriate JSPs;

FIG. 8 is a block diagram of a database layer of the web site architecture of an embodiment of the present invention, wherein the database layer includes data tables and lookup tables;

FIG. 9 is a block diagram illustrating the web site architecture of an embodiment of the present invention under one representative major category;

FIG. 10 is a block diagram illustrating the relationship of items with a product selection guide;

FIG. 11 is a block diagram of a summary listing of the web site architecture of an embodiment of the present invention, wherein the summary listing includes UPC numbers, catalog numbers, product names, comparison charts and detail pages and views;

FIG. 12 is a block diagram of a detail view of the web site architecture of an embodiment of the present invention, wherein the detail view includes product names, UPC numbers, catalog numbers, default pictures, text blocks, and accessory tables;

FIG. 13 is a block diagram of an accessory table of the web site architecture of an embodiment of the present invention, wherein the accessory table includes UPC numbers, catalog numbers, product names, prices and photos;

FIG. 14 is a block diagram of a search function of the web site architecture of an embodiment of the present invention, wherein the search function includes product names, UPC numbers and catalog numbers; and

FIG. 15 is a block diagram of a detail view of the web site architecture of an embodiment of the present invention, wherein the detail view includes a table of alternative parts, and/or a table of competitive products, and/or a table of subordinate products, if applicable.

### DETAILED DESCRIPTION OF THE ILLUSTRATED EMBODIMENTS

While this invention may be susceptible to embodiment in different forms, there is shown in the drawings and will be described herein in detail, an embodiment of the invention with the understanding that the present disclosure is to be considered an exemplification of the principles of the invention, and is not intended to limit the invention to that as illustrated.

An embodiment of the present invention provides a web site architecture which is configured to guide users through the process of selecting the best product for a specific job. The web site architecture guides users through the process of selecting the best product for a specific job by the user providing the web site with information about the job to be performed such that the web site can take this information, analyze it, and suggest to the user products cataloged on the web site which can perform the job to be performed.

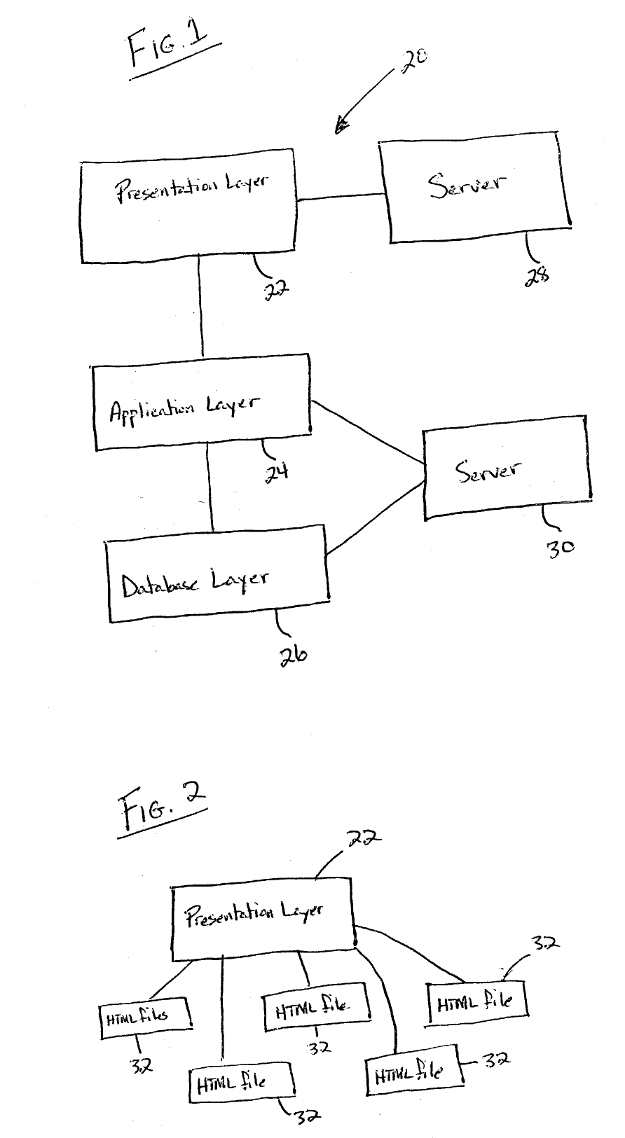

FIG. 1 illustrates a web site architecture 20 which is in accordance with such embodiment of the present invention. As shown, the web site architecture 20 is a three-tiered design, and includes a presentation layer 22, an application layer 24, and a database layer 26. Each layer 22, 24, 26 runs independently of the other layers 22, 24, 26 and can be separated both logically and physically. The three-tiered design allows for maximum flexibility and provides inherent security.

The web site architecture 20 utilizes first and second servers 28, 30, which are physically separate from one another. The presentation layer 22 is hosted on the first server 28, which is a web server. The web server 28 preferably runs AIX, a UNIX operating system sold by IBM. The web server 28 preferably further runs iPlanet Web Server.

The application layer 24 and the database layer 26 are hosted on the second server 30. The second server 30 preferably runs Solaris, a UNIX operating system sold by Sun Microsystems. To run the application layer 24, the second server 30 preferably further runs IBM WebSphere Application Server Advanced Edition. To run the database layer 26, the second server 30 preferably further runs IBM DB2 Universal Database. Of course, other programs may be chosen to run the different layers.

The presentation layer 22 is the highest of the three layers 22, 24, 26 in the architecture 20 and, as illustrated in FIG. 2, is formed of HyperText Markup Language (“HTML”) files 32 which are hosted on the first server 28. The HTML files 32 are platform-independent on both a client side and a server side. The HTML files 32 are configured to provide calls to the application layer 24 as necessary.

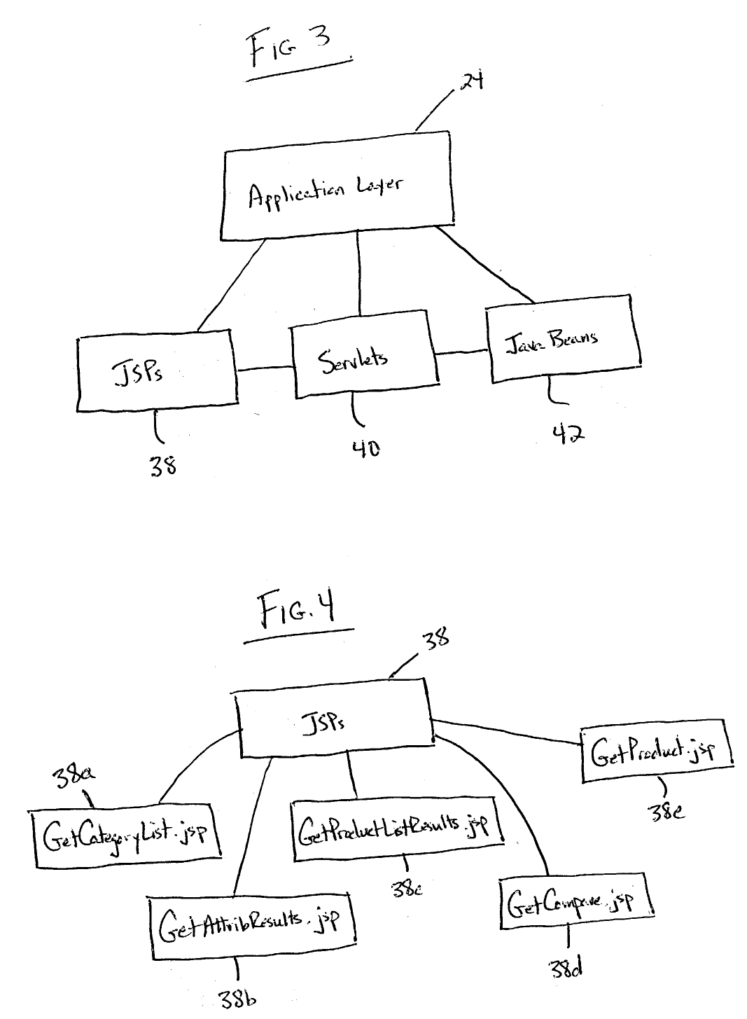

As shown in FIG. 1, the application layer 24 is the middle of the three layers 22, 24, 26 in the architecture 20. Preferably, the application layer 24 contains all business logic used to retrieve, manipulate and store data. The application layer 24 also dynamically compiles HTML files 32 to be sent back to the first server 28. Preferably, all processing is completed on the server side and only HTML files 32 are served to the client side. The application layer 24, as illustrated in FIG. 3, is formed of Java Server Pages (“JSPs”) 38, Servlets 40 and Java Beans 42. The JSPs 38, the Servlets 40 and the Java Beans 42 preferably conform to the J2EE standard, are truly platform independent, provide a high level of scalability, having complete security models, and provide an upgrade path for future performance via Enterprise Java Beans.

The web site architecture 20 is preferably based on the famous CMV (Control, Model and View) style. In the preferred embodiment, and as illustrated in FIG. 4, there are five JSPs 38, namely, GetCategoryList.jsp 38a, GetAttribResults.jsp 38b, GetProductListResults.jsp 38c, GetCompare.jsp 38d, and GetProduct.jsp 38e. Of course, the JSPs 38 and the number thereof could vary. The JSPs 38 manage the View.

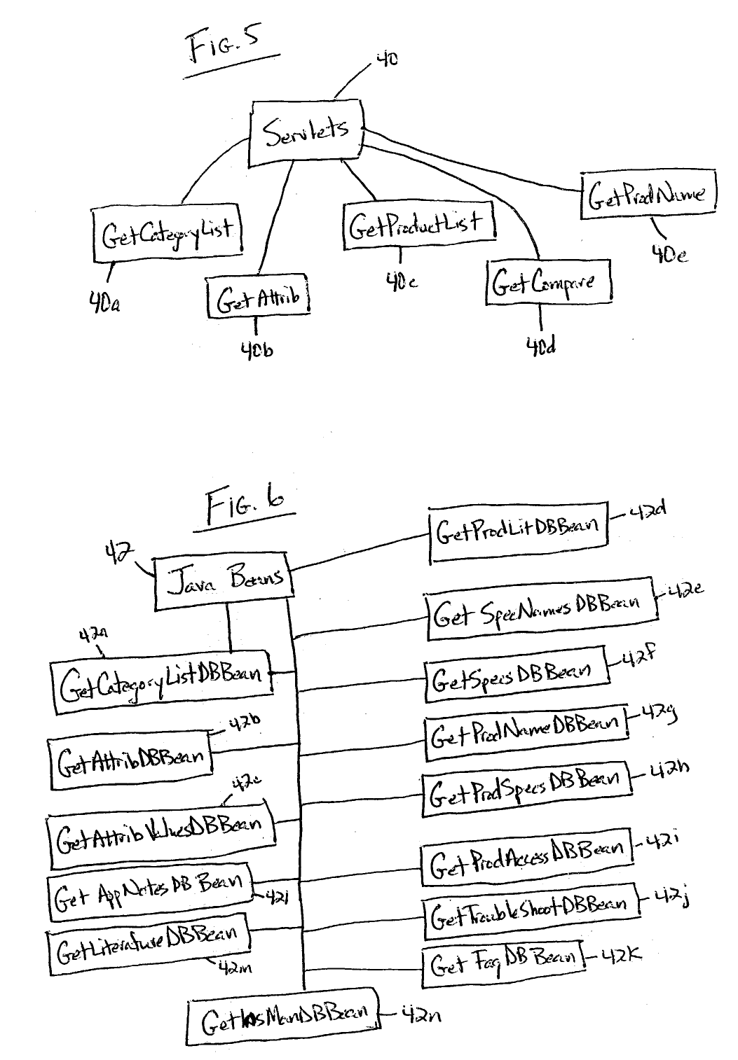

In the preferred embodiment, and as illustrated in FIG. 5, there are five Servlets 40, namely, GetCategoryList 40a, GetAttrib 40b, GetProductList 40c, GetCompare 40d, and GetProdName 40e. Of course, the Servlets 40 and the number thereof could vary. The Servlets 40 act as the Control and are hosted on the second server 30.

In the preferred embodiment, and as illustrated in FIG. 6, there are fourteen Java Beans 42, namely, GetCategoryListDBBean 42a, GetAttribDBBean 42b, GetAttribValuesDBBean 42c, GetProdLitDBBean 42d, GetSpecNamesDBBean 42e, GetSpecsDBBean 42f, GetProdNameDBBean 42g, GetProdSpecsDBBean 42h, GetProdAccessDBBean 42i, GetTroubleShootDBBean 42j, GetFaqDBBean 42k, GetAppNotesDBBean 42l, GetLiteratureDBBean 42m, and GetlnsManDBBean 42n. Of course, the Java Beans 42 and the number thereof could vary. The Java Beans 42 do modeling.

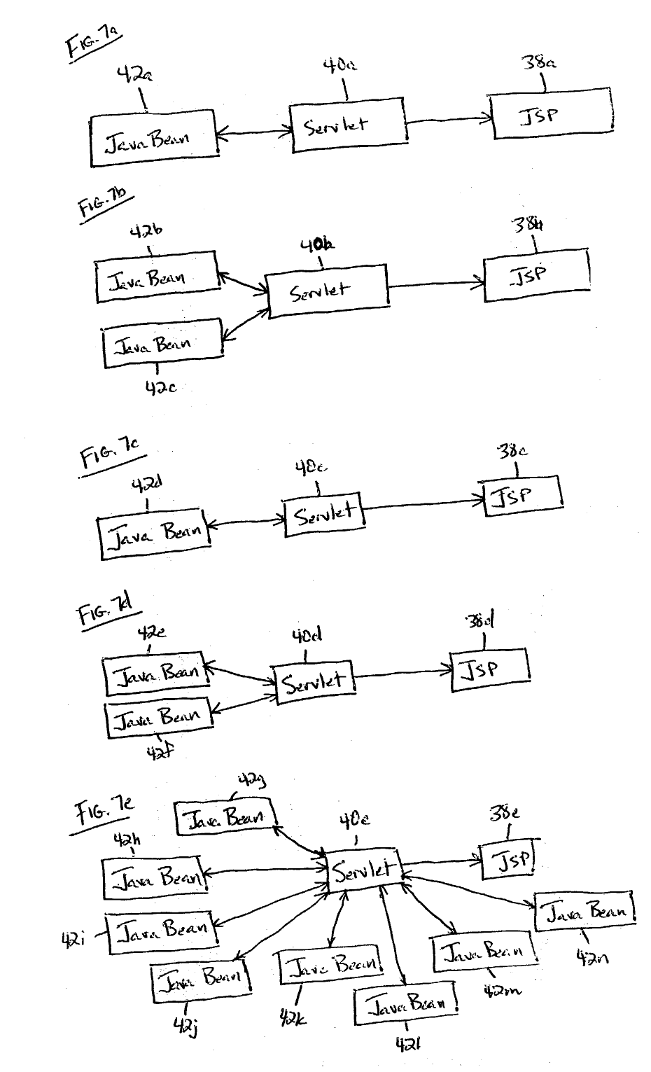

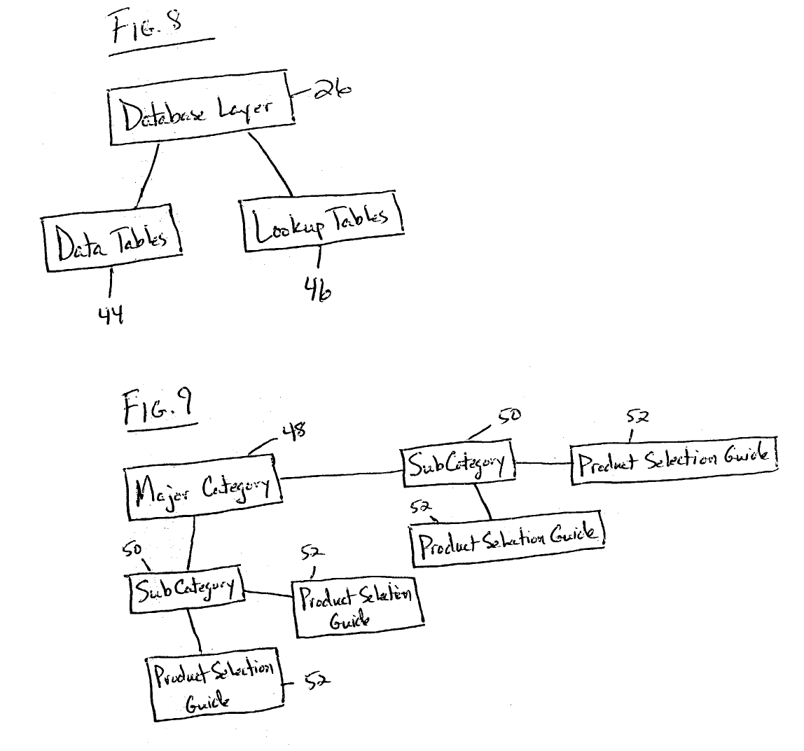

As illustrated in FIG. 7a, the Servlet 40a controls the activity of Category selection. The Servlet 40a is responsible for instantiating the Java Bean 42a, and then transferring the flow to the JSP 38a.

As illustrated in FIG. 7b, the Servlet 40b controls the activity of Attribute selection. The Servlet 40b is responsible for reading the Category Number, then instantiating the Java Bean 42b and the Java Bean 42c, and then transferring the flow to the JSP 38b.

As illustrated in FIG. 7c, the Servlet 40c controls the activity of Product selection. The Servlet 40c is responsible for readihg the Attributes, then instantiating the Java Bean 42d, and then transferring the flow to the JSP 38c.

As illustrated in FIG. 7d, the Servlet 40d controls the activity of comparing the selected products. The Servlet 40d is responsible for reading the Product Numbers, then instantiating the Java Bean 42e and the Java Bean 42f, and then transferring the flow to the JSP 38d.

Finally, as illustrated in FIG. 7e, the Servlet 40e controls the activity of displaying the Product Details. The Servlet 40e is responsible for reading the Product Number, then instantiating Java Bean 42g, Java Bean 42h, Java Bean 42i, Java Bean 42j, Java Bean 42k, Java Bean 42l, Java Bean 42m, and Java Bean 42n, and then transferring the flow to the JSP 38e.

The prime functionality of the Java Beans 42 is to manage the business logic. For instance, the Servlet 40a sets appropriate parameters of the Java Bean 42a and calls execute method. The Java Bean 42a then uses these parameters, communicates with the database layer 26, executes the SQL commands, and finally sets the result set or resulting parameters. The control of the application is still with the Servlet 40a. Thus, the Servlet 40a calls the JSP 38a. JSP 38a uses Java Bean 42a, retrieves the parameters, and displays them on the web page.

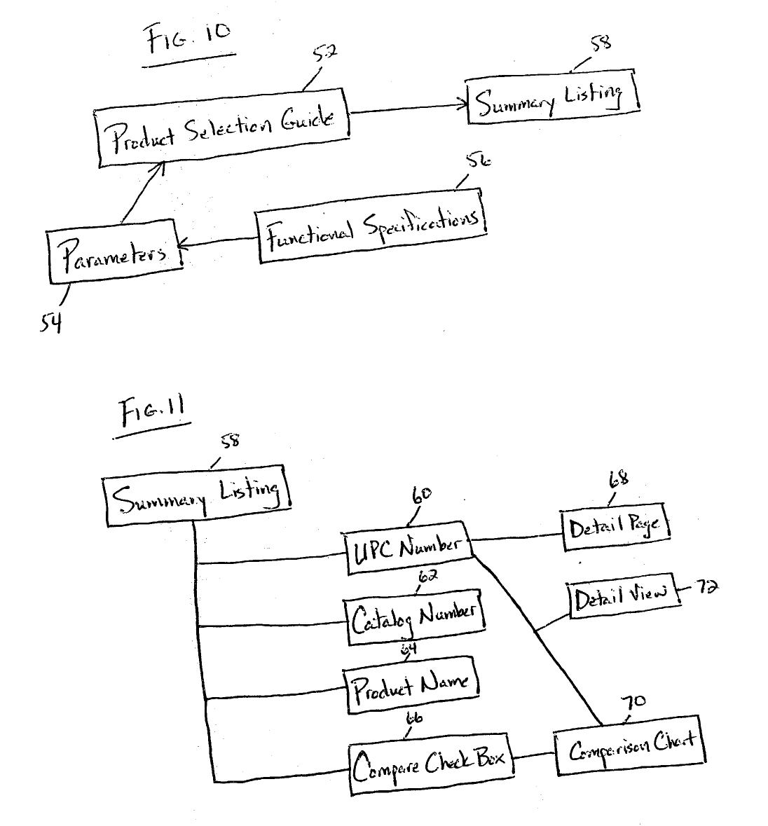

As shown in FIG. 1, the database layer 26 is the lowest of the three layers 22, 24, 26 in the architecture 20. Preferably, the database layer 26 is the core component of the web site architecture 20 and is a normalized database of all product and product-related information. As illustrated in FIG. 8, the structure of the database layer 26 is essentially a relational database containing several data tables 44 and lookup tables 46. The database layer 26 is hosted by the second server 30.

The web site architecture 20 provides a basic searchable catalog and allows users to find products that meet specific functional requirements which are provided to the web site by the user by inputting into the web site the specific job to be performed. The products are be stored in the database layer 26 and each product contains several functional specifications and attributes. As illustrated in FIG. 9, when a user initially enters the product information section of the web site, the user has the option of choosing any one of several major categories 48 (FIG. 9 shows the architecture 20 under one representative major category 48) of products from a drop-down list box. When an initial selection is made, another drop-down list box appears with sub-categories 50 relating to the previously selected major category 48. The combination of major category 48 and sub-category 50 directs the user to the corresponding product selection guide 52.

As illustrated in FIG. 10, the product selection guide 52 contains a series of searchable parameters 54. The parameters 54 are dynamically displayed on a page based on the functional specifications 56 of the current sub-category 50. The functional specifications 56 allow the user the option of creating a narrow or wide selection criterion that is used to display a list of products.

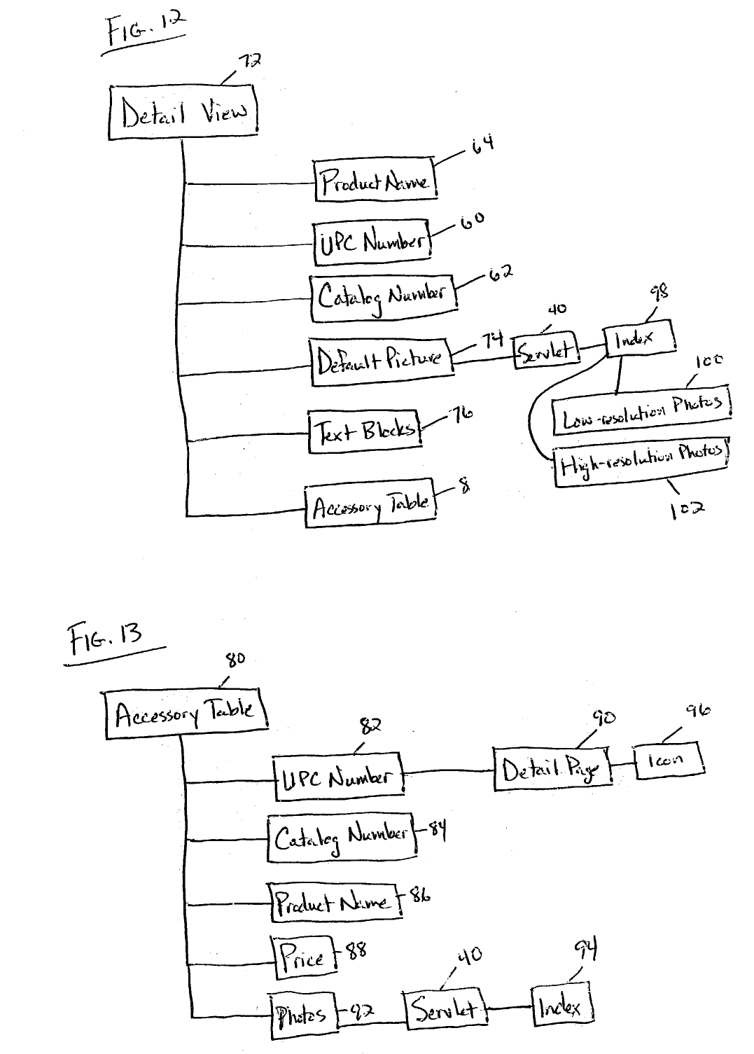

When two or more products meet a specified criterion, a summary listing 58 is displayed. As illustrated in FIG. 11, this table-like listing 58 may include the product UPC number 60, catalog number 62 and name 64. Preferably, there is also a compare check box 66 beside each product listed, and the UPC number 60 of the product is configured as a hyperlink to a detail page 68 of that product. By selecting any of the compare check boxes 66, a comparison chart 70 is dynamically created listing the products selected on the y-axis and the features of those products on the x-axis. This chart 70 provides a quick overview of the differences between products. The chart 70 also hyperlinks the product UPC number 60 to a detail view 72 of that product.

As illustrated in FIG. 12, the detail view 72 of a product preferably includes the product name 64, UPC number 60 and catalog number 62 followed by a default picture 74 of the product or product family. Description and features/benefits text blocks 76 are also displayed. If any literature, such as brochures, data sheets, MSDS or instruction manuals exist for the product selected, links to the related PDF files are displayed. The PDF files are referenced via the lookup tables 46 in the database layer 26 and the links are dynamically created for each product.

If there are any entries in the database layer 26 for troubleshooting tips, frequently asked questions (“FAQs”), or application notes related to the selected product, a link for each application function is displayed. The link for the troubleshooting function 80 displays a page which lists a table containing all symptoms related to the selected product. The symptom is a link to a detail view which displays the symptom, the problem, and a solution. The link for the FAQs function 82 displays a page which lists a table containing all frequently asked questions related to the selected product's category. The question is a link to a detail view which displays the question and the related answer. The link for the application notes function 84 displays a page which lists a table containing all titles of articles related to the selected product's category. The title is a link to a detail View which displays the article title and the text of the article.

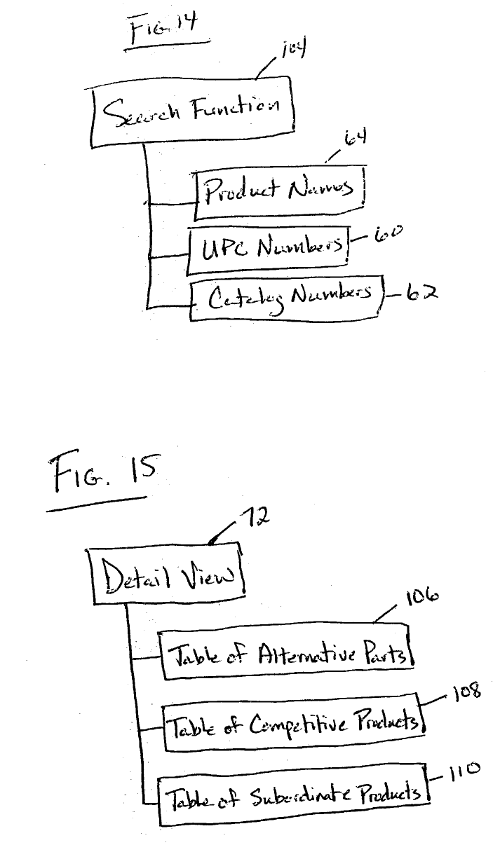

A table of functional specifications and attributes is generated dynamically. If the product displayed has associated accessories, preferably a table of accessory products 80 is displayed. As illustrated in FIG. 13, this accessory table 80 contains the product UPC number 82, catalog number 84, name 86 and price 88. The UPC number 82 is a hyperlink to a detail page 90 of that accessory item. If there is more than one photo (the default photo 92), a link to view more photos is displayed. The link launches another Servlet 40 that creates an index of thumbnails 94.

Also, if the detail view 72 of the product displayed has alternative, competitive or subordinate, i.e., repair parts, products associated therewith, preferably a table of alternative parts 106, and/or a table of competitive products 108, and/or a table of subordinate products 110 is displayed, as illustrated in FIG. 15.

Also on the product detail page 90, any promotions or special offers related to the product causes an icon 96 to be displayed beside the product image. This icon 96 is a hyperlink to a page listing the details of the promotion or special offer.

On the photo thumbnails index page 98, low-resolution photos 100, such as JPG and GIF, are displayed as graphical thumbnails linked to a full size file. High-resolution photos 102, such as TIFF and EPS files, are listed as a text link that is a hyperlink to the full size file. Each graphic 100, 102, whether high or low-resolution, displays the file name and size.

The web site architecture 20 preferably has a search function 104 which, as illustrated in FIG. 14, allows users to enter product names 64, UPC numbers 60 or catalog numbers 62 and get a listing of products matching the search criterion. The list of products preferably shows each product's UPC number 60, catalog number 62 and name 64. The UPC number 60 is linked to the photo thumbnail view.

List prices 88 are also on the database layer 26 and are displayed where a summary listing of products is displayed. List prices 88 are also displayed on the product detail pages and the product comparison pages. This pricing 88 is not intended to be used for making purchases, but provides an additional product comparison column to assist users in evaluating various products.

Preferably, the web site architecture 20 is configured to allow for multiple languages to be input.

Preferably, the web site architecture 20 is configured such that it runs on either an Internet web site or an Extranet web site. In an Extranet application, the web site architecture 20 allows distributors to use the application for buying decisions and custom pricing. A distributor is able to use the web site architecture 20 to browse product information and collect products for future order placement. The product summary listings and product detail pages displays both the list price 88 and the distributor's price. The web site architecture 20 also allows distributors to store orders on the site and retrieve the orders at a later date. Distributors can then easily place the same order periodically. Once an order is placed, the web site architecture 20 passes the order to the eSyte Customer Center application for final pricing and inventory calculations. Distributors wanting order status information is serviced by the eSyte Customer Center application. Thus, the Extranet web site allows distributors to handle pricing, inventory and tool selection.

The web site architecture 20 also has the capability to access the distributor database 108. End users are able to build a potential order including one or more products and submit, to the distributor of their choice, a request for quote. The distributor can then provide the end-user pricing and availability for their order.

If the web site that the web site architecture 20 is implemented on, has the ability to accept credit cards, the web site architecture 20 provides for the ability to sell directly to end-users. In having the credit card processing capability, any site can accept orders from distributors. If desired, the web site architecture 20 can look at distributor's inventories and, when an end-user wants to place an order, the web site architecture 20 can take the order on behalf of a distributor. This allows the end-users to complete an order and allows the distributor to make the sale.

The web site architecture 20 further has the capability of allowing both end users and distributors who have selected the products they wish to purchase, to enter the quantity of products that they wish to purchase and then receive a quote as to the price the quantity of products will cost the end user or distributor. Upon receiving the quote, the end user of distributors can then either accept the purchase at the quoted price or decline the purchase at the quoted rice.

While a preferred embodiment of the present invention is shown and described, it is envisioned that those skilled in the art may devise various modifications without departing from the spirit and scope of the foregoing description and the appended claims.

The invention is claimed as follows:

1. A web site architecture configured to guide users through the process of selecting a product for a job, said web site architecture comprising:
a presentation layer hosted on a first server;
an application layer hosted on a second server; and
a database layer hosted on said second server;
each said layer capable of operating independently of said other layers, each said layer capable of being separated both logically and physically from said other layers.

2. A web site architecture as defined in claim 1, wherein said presentation layer includes HTML files.

3. A web site architecture as defined in claim 2, wherein said HTML files are platform-independent on both a client side and a server side.

4. A web site architecture as defined in claim 2, wherein said HTML files are capable of providing calls to said application layer.

5. A web site architecture as defined in claim 1, wherein said first server is physically separate from said second server.

6. A web site architecture as defined in claim 1, wherein said first server is a web server.

7. A web site architecture as defined in claim 1, wherein said second server is an application/database server.

8. A web site architecture as defined in claim 1, wherein said application layer includes business logic which retrieves, manipulates and stores data.

9. A web site architecture as defined in claim 8, wherein said business logic dynamically compiles HTML files to be sent to said first server.

10. A web site architecture as defined in claim 8, wherein said business logic includes Java Pages, Servlets and Java Beans.

11. A web site architecture as defined in claim 10, wherein said Java Server Pages, said Servlets and said Java Beans are platform independent.

12. A web site architecture as defined in claim 10, wherein said Java Server Pages, said Servlets and said Java Beans provide a high level of scalability.

13. A web site architecture as defined in claim 10, wherein said Java Server Pages, said Servlets and said Java Beans have complete security models.

14. A web site architecture as defined in claim 10, wherein said Java Server Pages, said Servlets and said Java Beans provide an upgrade path for future performance via Enterprise Java Beans.

15. A web site architecture as defined in claim 10, wherein said Java Server Pages manage the view.

16. A web site architecture as defined in claim 10, wherein said Servlets act as controllers.

17. A web site architecture as defined in claim 10, wherein said Java Beans do modeling.

18. A web site architecture as defined in claim 1, wherein said database layer includes data tables and lookup tables.

19. A web site architecture as defined in claim 1, wherein products are stored in said database layer, each said product containing several functional specifications and attributes.

20. A web site architecture as defined in claim 1, wherein list prices are stored in said database layer.

21. A web site architecture as defined in claim 1, wherein said web site architecture can be run on both an Internet web site and an Extranet web site.

22. A web site architecture as defined in claim 1, wherein said web site architecture has the capability to access a distributor database.

23. A web site architecture as defined in claim 1, wherein said web site architecture can provide for the ability to sell directly to end-users if the web site has the ability to accept credit cards.

24. A method of selecting a product for a specific job over a web site, said method comprising the steps of:
providing a web site architecture having a presentation layer hosted on a first server, an application layer hosted on a second server and a database layer hosted on said second server;
entering a product information section of the web site;
inputting specified criterion into the web site about the specific job to be performed; and
receiving product information stored in the web site architecture from the web site about products capable of performing the specific job.

25. A method as defined in claim 24, wherein said presentation layer includes HTML files which provide calls to said application layer as necessary.

26. A method as defined in claim 24, wherein said application layer contains business logic used to retrieve, manipulate and store data, said application layer further dynamically compiling HTML files to be sent back to said first server.

27. A method as defined in claim 24, wherein said database layer is a normalized database of all product and product-related information.

28. A method as defined in claim 24, further including the step of displaying a summary listing when two or more products meet said specified criterion.

29. A method as defined in claim 28, wherein said summary listing includes at least one of a product UPC number, a catalog name, a product name, and a compare check box.

30. A method as defined in claim 29, wherein said product UPC number is a hyperlink to a detail page of said product.

31. A method as defined in claim 24, further including the step of providing a table of accessory products if said products have associated accessories.

32. A web site configured to receive information from a user, said information relating to a job to be performed using a tool, said web site configured to use said information to analyze a database of information relating to tools and determine which tools are acceptable for performing the job defined by the user, said web site configured to display a list of tools which have been determined by the web site to be acceptable to perform the job defined by the user.
